(19) United States
(12) Patent Application Publication
(10) Pub. No.: US 2013/0139961 A1
(43) Pub. Date: Jun. 6, 2013

(54) DUAL-SKIN STRUCTURES

(71) Applicants: Chris Gear, Ryde (GB); Eddie Jones, Shanklin (GB); Justin Elliott, Newport (GB); Dale Edmunds, Shanklin (GB); Giovanni Marengo, East Cowes (GB)

(72) Inventors: Chris Gear, Ryde (GB); Eddie Jones, Shanklin (GB); Justin Elliott, Newport (GB); Dale Edmunds, Shanklin (GB); Giovanni Marengo, East Cowes (GB)

(21) Appl. No.: 13/510,781

(22) PCT Filed: Nov. 19, 2010
(86) PCT No.: PCT/GB10/02154

§ 371 Date: Feb. 22, 2013

(30) Foreign Application Priority Data
Nov. 20, 2009 (GB) 0920391.0

(51) Int. Cl. B32B 37/02

(52) U.S. Cl. CPC B32B 37/02
USPC 156/247; 156/308.2; 156/60

(57) ABSTRACT

A dual-skin structure (10, 210) comprises a first skin (12, 112, 212), a second skin (14, 114, 214) and an intermediate structure (16, 116, 216). The intermediate structure (16, 116, 216) comprises a plurality of first contact portions (18, 118, 218) connected to an interior surface of the first skin (12, 112, 212), a plurality of second contact portions (20, 120, 220) connected to an interior surface of the second skin (14, 114, 214) and a plurality of interconnecting web portions integral to the first (18, 118, 218) and second (20, 120, 220) contact portions and extending between ones of the first (18, 118, 218) and second (20, 120, 220) contact portions to form an internal supporting structure (16, 116, 216) alternating between the interior surfaces of the first (12, 112, 212) and second (14, 114, 214) skins.

### FIELD

The present invention relates to an article of manufacture (hereafter an article) that comprises a dual skin structure and to method of manufacturing such an article. Such an article of manufacture having such a structure can be used, for example, in the aeronautics and aerospace industries.

### BACKGROUND

Dual skin structures are used in many different applications. For example, typical airframe designs for aerofoil structures comprise an essentially dual skin structure formed of individual piece parts. An upper and lower skin provides a smooth interface with the airflow surfaces. In known airframe designs, the upper and lower skin are typically spaced apart from each other and connected together with structural items, which are normally channel section structures known as spars, running in a span wise (wing length) direction. The spar functions to maintain the aerodynamic profile of the wing, to react to the majority of the loading subjected to the structure, to provide fuel tank boundaries (where applicable) and to provide a substantial load path to the route mounting arrangement for the wings. Ribs may also be included in such known airframe designs. These are chord wise structures (extending in the direction of flight), which also connect together the upper and lower skins and provide various functions. These functions can be to maintain the aerodynamic profile of the wing, to transfer air pressure collected from the skins to the spars, to diffuse locally concentrated load inputs, to redistribute wing bend loads, to provide lateral end support for skin and stringer buckling, to react crushing forces away from the spars, and to support internal systems. Such a conventional arrangement is typically provided by the use of metallic fasteners such as rivets and bolts.

It is also known to use both metallic and composite variants of and combinations thereof. The complexity of such aerofoil structures coupled with the requirement to match geometries, and the sheer number of piece parts, make such conventional techniques inefficient and expensive.

It would be desirable to reduce the piece count and installation time for such structures, to reduce the numbers of fasteners and the installation time for the fasteners, to minimise the part interface considerations, to produce potentially lighter solutions, and to make available automated manufacturing methods, where possible.

The aim of the present invention is to address at least some of these aims.

### SUMMARY

Particular aspects of the invention are set out in the accompanying independent and dependent claims. Combinations of the features from the dependent claims may be combined with the features of the independent claims as appropriate and not merely as explicitly set out in the claims.

An aspect of the invention provides an article that comprises: a first skin; a second skin; and an intermediate structure that comprises a plurality of first contact portions connected to an interior surface of the first skin, a plurality of second contact portions connected to an interior surface of the second skin and a plurality of interconnecting web portions integral to the first and second contact portions and extending between ones of the first and second contact portions to form an internal supporting structure alternating between the interior surfaces of the first and second skins.

In one example, the article is a winglet configured to extend upwards from the end of a wing.

Another aspect of the invention provides a deltoid filler for an external angle between a first laminated composite member, and a second laminated composite member, the second composite laminate member comprising a first portion adjacent the first composite laminate member and a second portion extended away from the first composite laminate member at an angle thereto.

An aspect of the invention provides a method of manufacturing an article that comprises a first skin, a second skin and an intermediate structure that comprises a plurality of first contact portions connected to an interior surface of the first skin, a plurality of second contact portions connected to an interior surface of the second skin and a plurality of interconnecting web portions integral to the first and second contact portions and extending between ones of the first and second contact portions to form an internal supporting structure alternating between the interior surfaces of the first and second skins, the method comprising: separately forming the first skin, the second skin and the intermediate structure from composite materials; and assembling the article using at least one method step of co-curing the first skin, the second skin and the intermediate structure.

Another aspect of the invention provides a method of reinforcing an external angle formed between a first laminated composite member and a second laminated composite member, the second composite laminate member comprising a first portion adjacent the first composite laminate member and a second portion extended away from the first composite laminate member at an angle thereto, the method comprising forming an external deltoid filler formed of composite material in the external angle between the first laminated composite member and the second laminated composite member.

A further aspect of the invention provides a method of forming an intermediate structure for an article that comprises a first skin, a second skin and the intermediate structure, the method comprising: stacking sheets of pre-impregnated fibres over mandrels and a second tool, the mandrels being releasably mounted on the second tool, wherein the sheets of pre-impregnated fibres comprise petals of fibres interleaved such that the petals overlap at a first contact portion to provide the intermediate structure with a greater thickness at the first contact portion than at an intermediate portion.

### BRIEF DESCRIPTION OF THE DRAWINGS

The features, advantages and technical and industrial significance of this invention will be described in the following detailed description of example embodiments of the invention with reference to the accompanying drawings, wherein the same or corresponding portions will be denoted by the same reference numerals.

FIG. 1 is a schematic representation of a dual skin structure.

FIG. 2 is a cross sectional view of the dual skin structure of FIG. 1.

FIGS. 3A to 3G provide a schematic representation of an example method for producing the dual skin structure of FIGS. 1 and 2.

FIG. 4 is a detail of the manufacturing method shown in FIG. 3.

FIG. 5 is a further detail of the manufacturing method shown in FIG. 3.

FIG. 6 is a schematic representation of an aircraft.

FIGS. 7A and 7B are schematic representations of a winglet of the aircraft of FIG. 6.

FIGS. 8A and 8B are schematic representations of another example of the winglet of the aircraft of FIG. 6

FIG. 9 is a schematic diagram illustrating options for producing a winglet as shown in FIG. 6.

### DESCRIPTION

Example embodiments will now be described in the following with reference to the accompanying drawings.

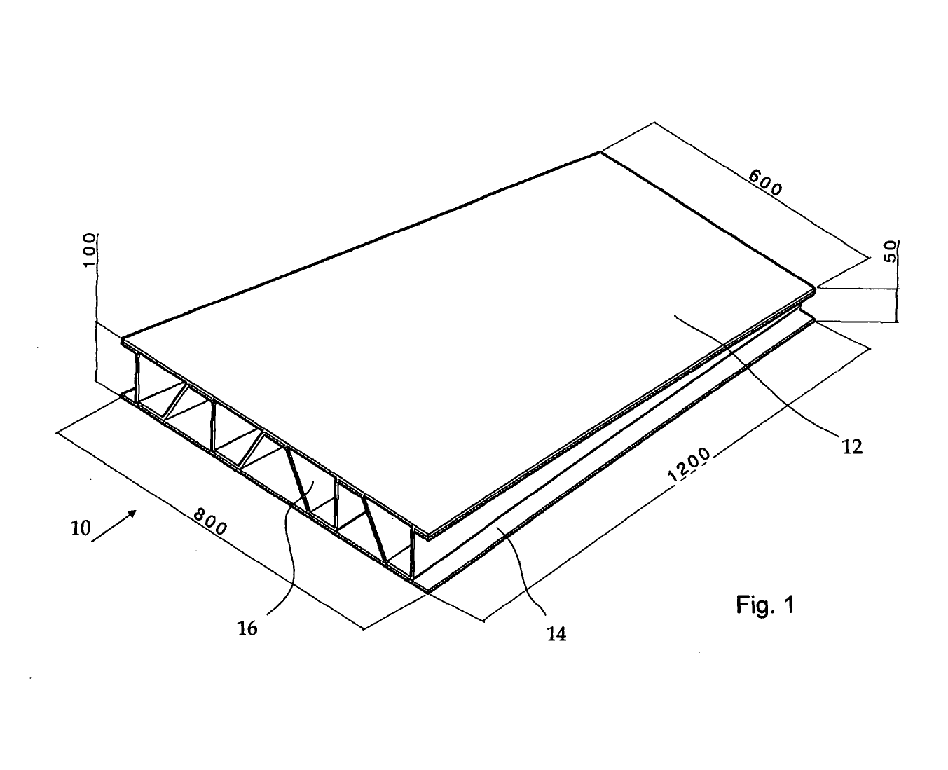

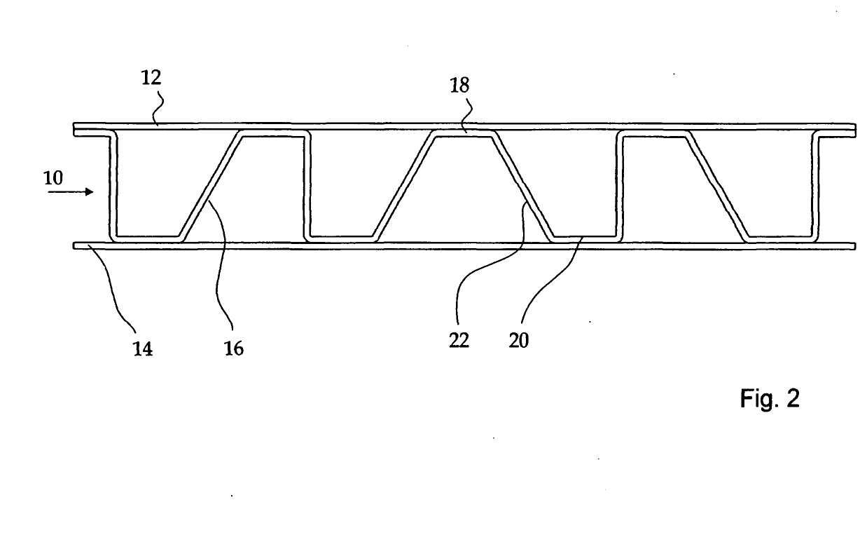

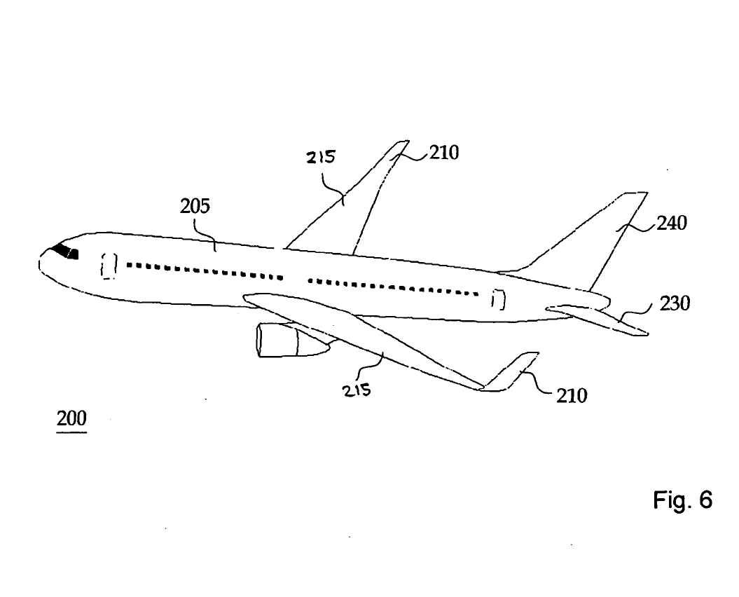

Example embodiments of the invention will be described hereinafter by way of example only. Examples of dual-skin structures including an internal corrugated or waffle-shaped structures are described. In the following description, FIGS. 1-5 are used to describe an approach to manufacturing an example article as shown in FIGS. 1 and 2. FIGS. 6-9 are then used to describe a particular example in the form of an aerofoil structure, specifically a winglet. However, it is to be noted that the invention is not related to the specific articles shown and the manufacture thereof, but can be employed in a wide variety of other articles that include a dual-skin structure.

Example embodiments of articles of manufacture are described that include a dual-skin structure that comprises a first skin, a second skin and an intermediate structure. The intermediate structure comprises a plurality of first contact portions connected to an interior surface of the first skin, a plurality of second contact portions connected to an interior surface of the second skin and a plurality of interconnecting web portions integral to the first and second contact portions and extending between ones of the first and second contact portions to form an internal supporting structure alternating between the interior surfaces of the first and second skins.

For example, FIG. 1 is a schematic representation of an article of manufacture that comprises a dual-skin structure 10 that includes an upper skin 12, a lower skin 14 and an intermediate supporting structure 16. In the example shown, the intermediate supporting structure is formed as a unitary intermediate member having a generally corrugated or waffle-shaped form. In the example shown, the intermediate structure defines a plurality of channels that extend in a length-wise direction of the dual-skin structure 10. As shown in the example, the dual-skin structure tapers from the lower left hand to the upper right hand portion shown in FIG. 1, from a width of approximately 800 mm at the bottom left hand end to 600 mm at the upper right hand end, and varies in thickness between approximately 100 mm at the bottom left hand end to approximately 50 mm at the upper right hand end. The overall structure shown in FIG. 1 is approximately 1200 mm long. In the particular example shown, the channels defined by the intermediate structure extend the whole length of the dual skin structure 10 and are tapered, being wider and higher at the bottom left in FIG. 1 and narrower and shorter at the top right in FIG. 1. The tapering facilitates the removal of tooling as used during manufacture. In other examples at least some of the channels could extend only part way along the article. It will be appreciated that the dimensions and shape of the article shown in FIG. 1 are for illustrative purposes only, and are non-limiting. It should be noted that the “article” can, for example, be a component of or a part of a more complex device or an apparatus, the term “article” being used herein to identify that it is an article of manufacture in its broadest sense.

FIG. 2 shows an end view of the dual-skin structure 10. This shows in more detail the upper skin 12, the lower skin 14 and the intermediate structure 16 which includes first contact portions 18 that contact the upper skin 12, second contact portions 20 that contact the lower skin 14 and intermediate portions 16 that extend between the upper and lower contact portions 18 and 20 to form a unitary, or integrated, internal structural member 16. In the cross section shown in FIG. 2, the first contact portions 18 each extend substantially linearly parallel to and in contact with the inner surface of the upper skin 12 and the second contact portions 20 each extend substantially linearly parallel to and in contact with the inner surface of the lower skin 14. The extent of the contact portions can be chosen according to specific example to provide for structural integrity of the dual skin structure though the co-curing and/or fasteners used as described in the following. In the cross section as shown in FIG. 2, the intermediate portions 16 that extend between the upper and lower contact portions 18 and 20 are substantially linear and extend at an angle to the aforementioned inner surfaces of the upper and lower skins 12 and 14, and the first and second contact portions 18 and 20. The use of substantially linear portions as illustrated in the cross section in FIG. 2 provides enhanced structural strength and reduced weight compared, for example, to an undulating or sinusoidal cross section. In an example embodiment, the upper skin 12, the lower skin 14 and the intermediate structure 16 are each formed of laminated composite materials, for example carbon fibre reinforced composite material. One or more of the contact portions 18, 20 and the intermediate portions 22 can further have holes or apertures formed therein, and/or can be provided with sections of differing thicknesses according to weight and structural requirements of a particular specific application.

The composite material(s) used to make the composite structure according to an embodiment of the invention may be unidirectional pre-impregnated composite material. Alternatively, the material used may be pre-impregnated woven fabric. Alternatively, the material used may be dry woven fabric. The composite material may comprise dry woven fabric interleaved with resin film. Examples of suitable composite materials include carbon fibres, aramid fibres or glass fibres or a combination of carbon fibres and aramid fibres or a combination of aramid and glass fibres or a combination of carbon and glass fibres or a combination of carbon, aramid and glass fibres. The skins and the intermediate structure can each be formed by laminating multiple layers, or sheets, of the material of choice with, for example, the fibres of respective sheets oriented in different directions.

In an example embodiment, the upper skin 12, the lower skin 14 and the intermediate structure 16 are laid down in separate processes and then are co-cured to form the dual-skin component 10. One of the skins (for example lower skin 14), can be co-cured using a release agent, and can be reattached to the intermediate structure using fasteners as will be described hereinafter.

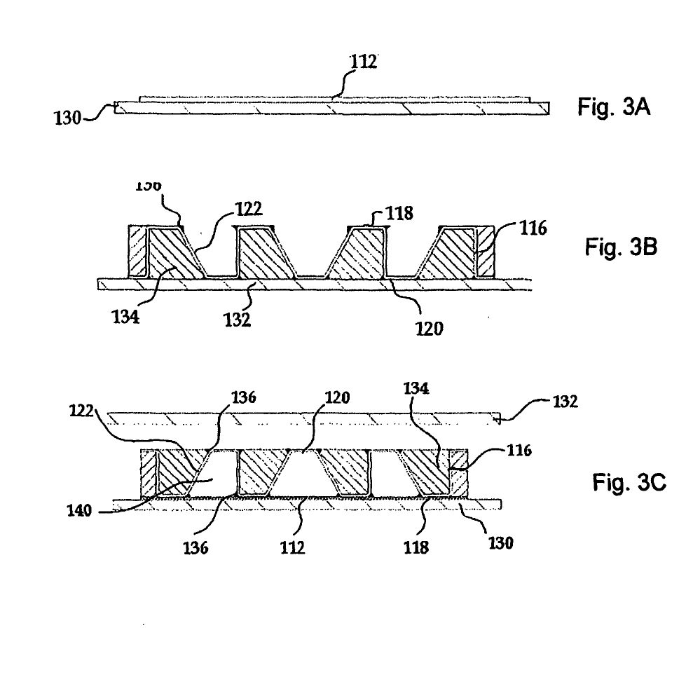

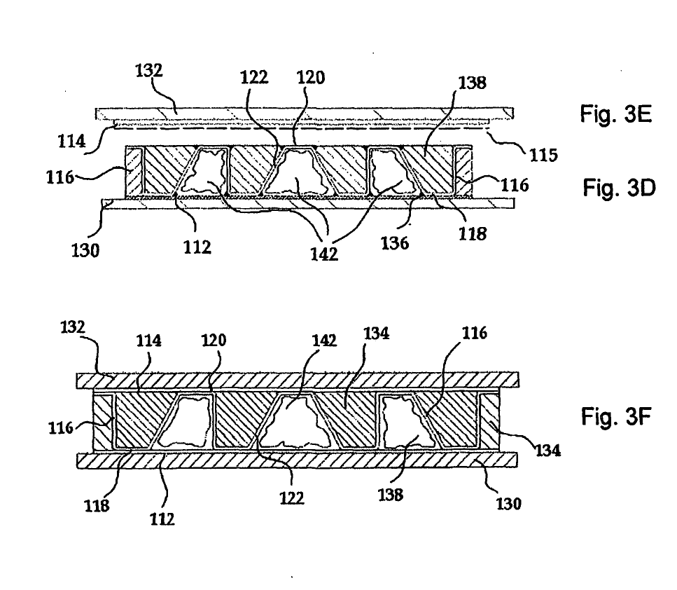

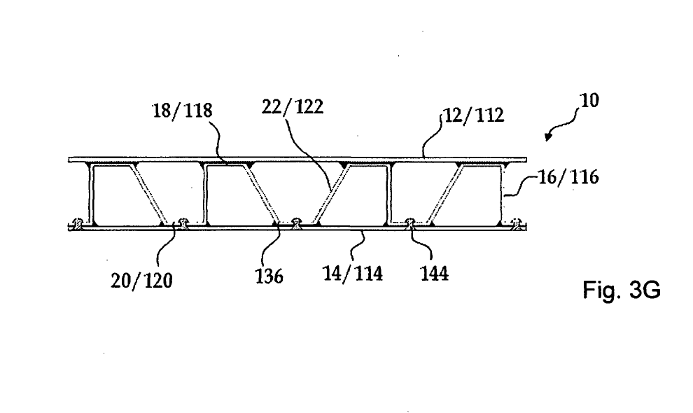

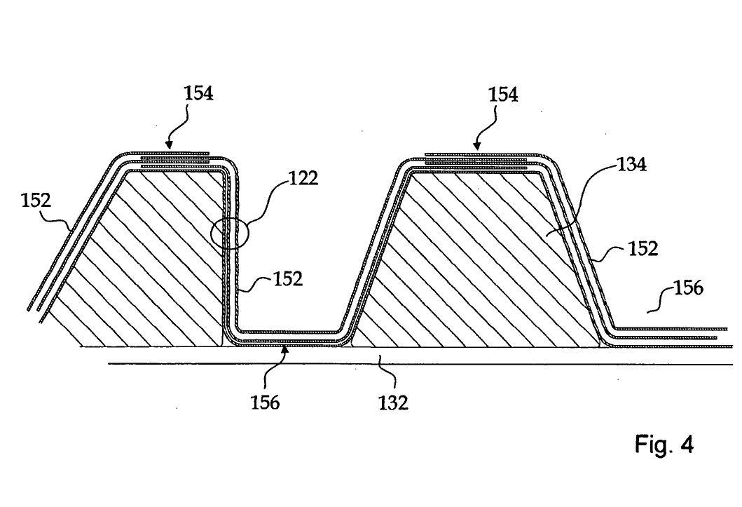

FIG. 3 comprises schematic drawings FIG. 3A, FIG. 3B, FIG. 3C, FIG. 3D, FIG. 3E, FIG. 3F and FIG. 3G representing different stages in a process of forming the dual-skin structure of the component 10 of FIG. 1.

FIG. 3A represents an initial step of laying down a stack 112 to form the upper skin 12 of the dual-skin structure 10. In the present example, the skin stack comprises six pre-impregnated carbon fibre sheets (or plies) laid on an aluminium alloy tool 130. The respective sheets of the skin stack 112 can be laid down by hand or machine, as appropriate, with the sheets of respective layers in different directions to increase the structural characteristics of the skin stack 112 in accordance with known techniques.

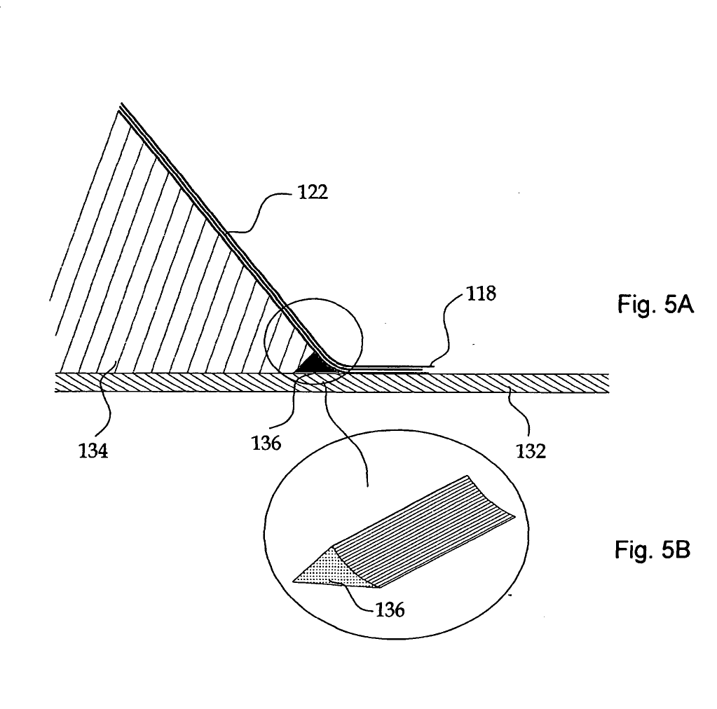

FIG. 3B illustrates forming of the intermediate structure 16 by laying down a plurality of pre-impregnated carbon fibre sheets (e.g. six layers of sheets) over aluminium alloy mandrels 134 that are bolted to an aluminium alloy tool lower skin tool 132 in a predetermined configuration. The respective sheets of the intermediate structure 116 can be laid down by hand or machine, as appropriate, with the sheets of respective layers in different directions to increase the structural characteristics of the intermediate structure 116 in accordance with known techniques. As described later with reference to FIG. 5, deltoid fillers (or deltoids) 136 can be provided at the junction between mandrels 134 and the lower skin tool 132 to facilitate the laying of the sheets of the intermediate structure 116 between the contact portion 118 and the intermediate portion 122. After the laying of the sheets of the intermediate structure 116, further deltoid fillers 136 can also be located on the exterior of the angles formed between the intermediate portions 122 and the contact portions 120. The locations of the deltoid fillers 136 are illustrated schematically in FIG. 3B by black triangles.

FIG. 3C illustrates the bringing together of the upper skin stack 112 formed in step 3A and the intermediate structure 116 formed in step 3B to form a sub-assembly of the upper skin stack 112 and the intermediate structure 116. In this process, the intermediate structure of FIG. 3B is inverted and then placed onto the upper skin stack 112. In this orientation, channels 140 are formed by the cavities between the upper skin stack 112, and the intermediate portions 122 and the lower contact portions 120 of the intermediate structure 116. The lower skin tool backing plate 132 is unbolted from the mandrels 134 and is removed, as represented in FIG. 3C. This then means that the upper contact portions 118 are at the bottom of the intermediate structure as shown in FIG. 3C and contact the inner surface of the lower skin stack 112.

In step 3D, pressure bags, or tubes, 142 are inserted into the channels 140 between the upper skin stack 112, and the intermediate portions 122 and the lower contact portions 120 of the intermediate structure 116. During curing, the pressure bags or tubes 142 are open to atmospheric pressure which means that the bags form soft tooling structures that apply pressure to the internal surfaces of the channels formed between the upper skin stack 112, and the intermediate portions 122 and the lower contact portions 120 of the intermediate structure 116. This pressure helps maintain the structural and dimensional stability of the upper skin stack 112 and intermediate structure during curing. Deltoids 136 (which were formed at the upper exterior portions of the angles between the intermediate portions 122 and the upper contact portions 118 in FIG. 3B) form a smooth interface between the intermediate portions 120 and the upper skin stack 112 to avoid snagging of the pressure tubes 142 within the channels 140.

FIG. 3E shows a lower skin stack 114 after being formed on the backing plate 132, which also forms the lower skin tool 132, finishing with a release film 115 and then inverting the lower skin tool 132. In one example the lower skin stack could be formed from six layers of sheets of pre-impregnated carbon fibre sheets. When using the backing plate 132 for laying down the lower skin stack 114, holes in the backing plate that were used for bolting the mandrels can be filled with a flash breaker and the lower skin stack 114 can be formed in the same manner as the upper skin stack of FIG. 3A. As an additional, step in the example shown in FIG. 3E, a release film 115 is provided on the lower skin stack 114. The release film can be provided by a release compound, a vacuum bag layer, or any other appropriate technique. As indicated above, FIG. 3E shows a configuration after the formation of lower skin stack 114 as described above and after the inversion of the lower skin tool 132 so that the lower skin stack 114 is underneath the inverted lower skin tool 132.

FIG. 3F illustrates the application of the lower skin stack 114 at the appropriate location to the structure shown in FIG. 3D. The structure shown in FIG. 3F can be held together using appropriate fastening or holding means, and can then be co-cured, using any appropriate conventional technique. For example, the curing could be performed by inserting the assembly shown in FIG. 3F into a vacuum bag and curing in an autoclave. Alternatively, a double diaphragm technique could be used (an example of a double diaphragm forming approach for a complex structure is described, for example, in WO/2009/066064). During the curing process, the application of vacuum to the external vacuum bag means that the pressure tubes 142, which are maintained at atmospheric pressure, maintain the structural integrity of the intermediate structure 116 and the upper skin stack 112. The structural integrity between the intermediate structure 116 and the lower skin stack 114 is effected as a result of the mandrels 134.

During the co-curing process, the lower skin stack becomes integrally bonded to the intermediate structure 116. Also, the deltoid fillers 136 become integrally bonded to the adjacent structures (for example, the intermediate portions 122 of the intermediate structure 116) and, where this is adjacent, the lower skin stack 112. Bonding of the intermediate structure 116 and the deltoid fillers 136 to the lower skin stack is prevented by the release film. However, nevertheless, the contact surfaces of the lower contact portions 120 of the intermediate structure 116, and the deltoids 136 to the interior surface of the lower skin stack are substantially identically shaped (i.e. they are conformed or matched to each other), which facilitates later assembly as described with reference to FIG. 3G.

After the co-curing process, the cured upper skin stack is removed with the upper skin tool and is released therefrom. The mandrels 134 are removed, and, where possible, the pressure bags 142 are also removed. The lower skin is then reattached to the intermediate structure using appropriate fasteners 144 (or example, fasteners such as studs, rivets, screws, bolts, etc. made of suitable materials such as materials such as carbon fibre, metals (e.g., aluminium) etc.) and finally the upper skin tool is removed. The structure can then be inverted to provide the resulting structure as shown in FIG. 3G.

Due to the co-curing process, the fit between the lower skin 12 and the intermediate structure 16 is substantially perfect so that post machining after curing is not required. Further, the use of the increased depth of the intermediate structure 16 in the area of the lower contact portions 20 facilitates the use of fasteners for re-attaching the lower skin 14.

In the example shown, the lower skin 14 is attached to the intermediate structure using fasteners, whereas the upper skin is attached to the intermediate structure 16 as a result of the co-curing process. It will, however, be appreciated that instead of the lower skin being attached by fasteners and the upper skin being attached by co-curing, this arrangement could be inverted with the upper skin being attached by fasteners and the lower skin by co-curing. Further, in a further embodiment, by suitably arranging the tapering of the channels from one end to the other, the mandrels could be extracted from an end of the channel whereby disassembly following the step shown in FIG. 3F and then reassembly in the step shown in FIG. 3G is no longer necessary. In such an embodiment, the release film would be omitted from step shown in FIG. 3E, whereby, in the step shown in FIG. 3F, the upper and lower skins 12 and 13 would both be attached to the intermediate structure 16 by the co-curing process.

In the processes described above, so-called z-pins (e.g., carbon fibre pins), clamps, etc, can be used facilitate the location and holding of the skins and the intermediate structure together for the curing process.

Although in the above example six layers of fibre reinforced sheets are used, this number of layers is by way of illustration only, and the number of layers of material to created the first and second skins and the intermediate structure and be chosen according to the loading and dimensional requirements of a particular application. Also, the numbers of layers may not be uniform across the dual skin structure, but may be different at different positions of a particular example structure according to weight requirements, sizes, loading and other structural requirements, etc.

The curing process as described above with reference to FIG. 3F can be effected by the application of external heat, for example by carrying out the curing process in an autoclave. Alternatively, or in addition, heat can be applied by tools that are self heated, for example using tools 130 and 132 and mandrels 134 that include internal heating elements. It should also be noted that although in the examples described above, the tools and the mandrels are described as being of aluminium alloy, in other examples, the tools and the mandrel could be made of or comprise other materials, such as other metals and/or composite materials.

FIG. 4 illustrates a detail of a technique for laying down respective sheets to provide areas of increased thickness. For example, as shown in FIG. 4, the sheets can extend between and cover the upper surfaces of the adjacent mandrels and be interleaved and overlapped as shown at 154, so that the portion of the intermediate structure 116 at 154 has a greater thickness than the portion of the intermediate structure 116 at 152. This approach to laying the sheets can provide an additional thickness available for using fasteners later in the manufacturing process, as will be described later. The areas in which the sheets are overlapped to give additional thickness can be as shown at 154. With this approach, the contact portions 20 as shown in FIG. 2 for contacting the lower skin 14 can be provided with additional thickness to facilitate the use of fasteners while allowing the remainder of the intermediate structure to be as light as possible. As an alternative, or in addition, the overlapping layers (as shown at 154 in FIG. 4) could be provided instead, or in addition, at the location(s) 156 as shown in FIG. 4, whereby the contact portions 18 for contacting the upper skin 12 as shown in FIG. 2, could be provided with additional thickness to facilitate the use of fasteners.

FIG. 5 illustrates additional detail of the step shown in FIG. 3B, whereby a deltoid filler 136 is provided at the junction between mandrels 134 and the lower skin tool 132 to facilitate the laying of the sheets of the intermediate structure 116 between the contact portion 118 and the intermediate portion 122. The deltoid filler 136 (as shown in more detail in FIG. 5B) enhances the structural characteristics of the angle formed between the portions 118 and 112 as shown in FIG. 5A. The deltoid filler 136 can be formed, for example, from pre-impregnated carbon composite material with carbon fibres extending coaxially along the length of the deltoid filler. Alternatively, the deltoid filler can include not only longitudinally extending fibres, but also fibres extending in other directions, as required by the structural requirements of a particular embodiment. For example the fibres can be braided. The deltoid filler can be placed into an appropriately formed shape between the base of the mandrel 134 and the lower skin tool 132, and due to the sticky nature of a pre-impregnated composite part, the deltoid filler 136 will be held in place during laying of the sheets of the intermediate structure 116. As mentioned with reference to FIG. 3B, after laying of the sheets of the intermediate structure 116, further deltoid fillers 136 can be located on the exterior of the angles formed between the intermediate portions 122 and the contact portions 120.

FIG. 6 is a schematic representation of an aircraft 200. The aircraft comprises a fuselage 205, wings 215 forming main lifting services, tail planes 230 forming rear lifting surfaces and a tail fin 240. The main wings 215 comprise winglets 210 at the ends thereof to enhance the aerodynamic efficiency of the main wings 215. Each of the aerodynamic surfaces formed by the main wings 215, the winglets 210, the tail planes 230 and the tail fin 240 form aerodynamic surfaces that can be constructed using a dual-skin construction such as the dual-skin construction described with reference to FIGS. 1-5.

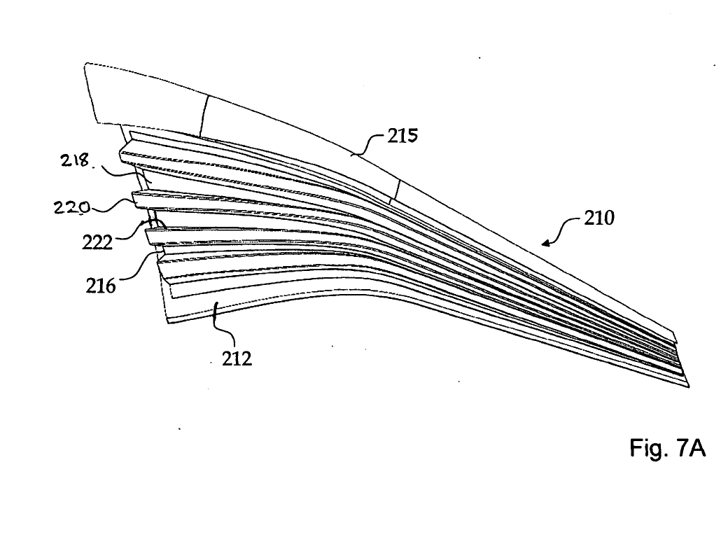

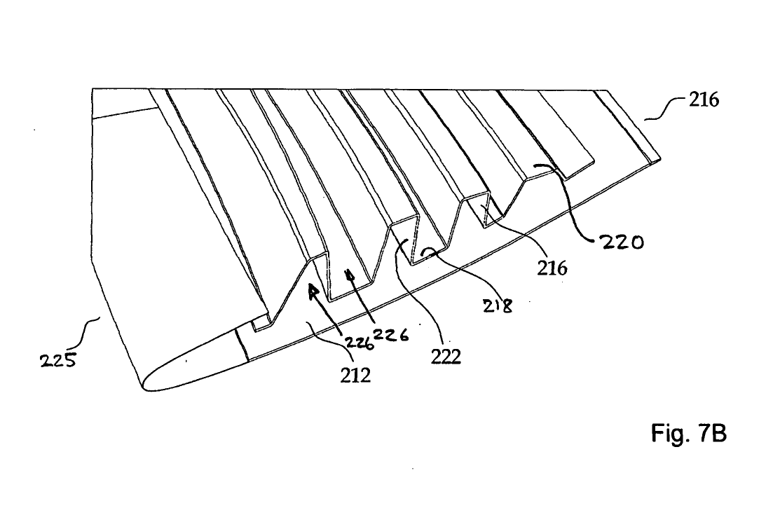

FIG. 7A is a schematic representation of a winglet assembly prior to fastening of a lower skin (not shown). FIG. 7A shows a view from below of the winglet assembly 210 and shows the leading edge 225, the interior of the upper surface 212 and the intermediate structure 216, with the contact portion 218 or 220 of the intermediate structure 216 for contacting the inner surfaces of the upper skin 212 and the lower skin (not shown). As illustrated in FIG. 7, the channels formed between adjacent intermediate sections extend in the span-wise direction, with the intermediate portions 222 of the intermediate structure 216 forming spars for separating and supporting the upper and lower skins with respect to each other. FIG. 7A illustrates the tapering of the channels from left to right in FIG. 7A formed by the intermediate structure 216.

FIG. 7B shows a portion of the structure of FIG. 7A in slightly more detail showing the ends of the channels 226 formed between the intermediate portions 222 of the intermediate structure 216, the appropriate contact portion 218 or 220 of the intermediate structure 216 and the opposed interior surface of the upper skin 212 or the lower skin (not shown), respectively.

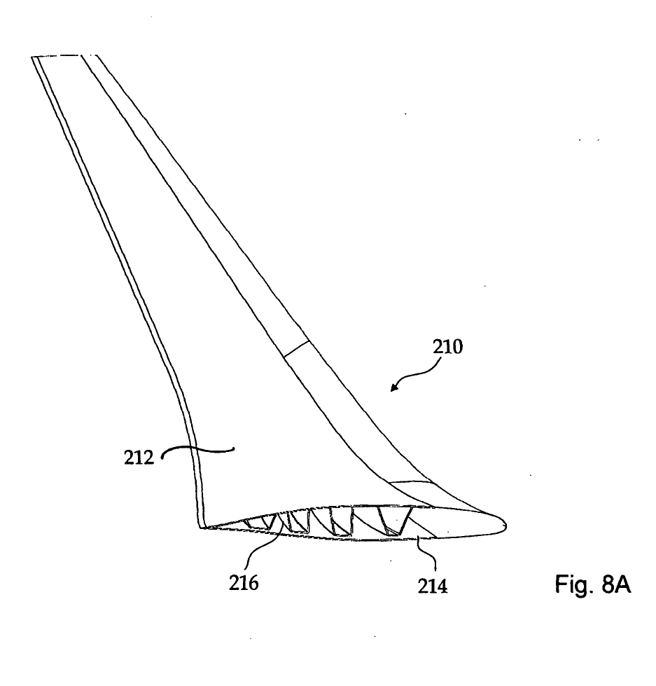

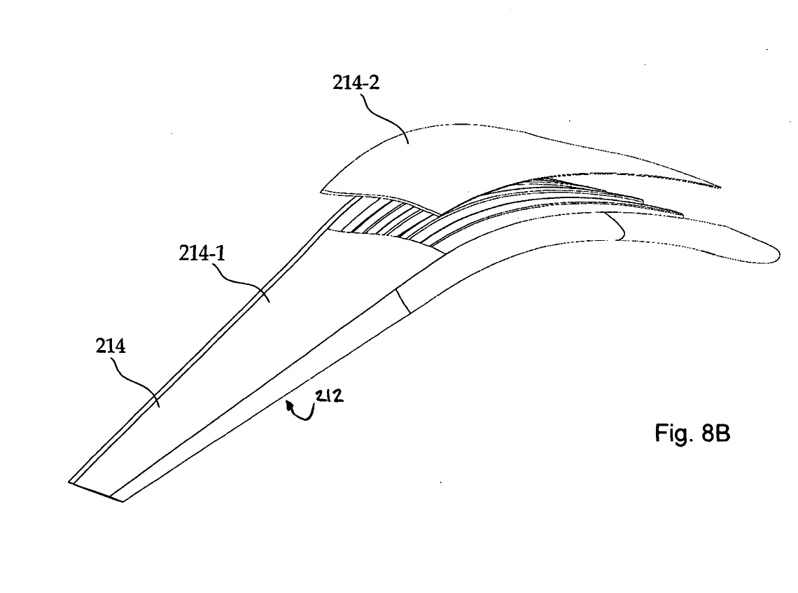

FIG. 8A illustrates a view of the winglet assembly 210 as looking outwardly (in a spar-wise direction) along a wing, and shows the upward curve of the winglet 210. FIG. 8 also shows the section through the winglet with the upper skin 212, the lower skin 214 and the intermediate structure 216 formed therebetween.

FIGS. 7A and 7B show a structure where the complete length of the lower skin is attached after co-curing (for example, using the process as described with reference to FIGS. 3A-3G) using a release film in step 3E.

FIG. 8B shows an alternative construction whereby the mandrels 134 are extracted longitudinally from the tapering channels formed between the inner and lower skins 212 and 214. In order to achieve this, the lower skin 214 is formed in two parts. The part 214-1 is assembled without using a release film so that, during the co-curing process, the lower skin 214-1 becomes firmly bonded to the intermediate structure 216. However, the portion at the fuselage end of the winglet 210 is formed such that the lower surface 214-2 is provided with a release film in step 3E, whereby that portion of the lower skin is removed following step 3F of FIG. 3 and the mandrels 134 can then be extracted from the winglet 210. Following extraction of the mandrels, the end portion 214-2 of the lower surface 214 is then reattached using fasteners, as illustrated in FIG. 3G.

As indicated above, the numbers of layers of fibres used to create the laminated first and second skins and the intermediate structure is chosen according to parameters such as weight requirements, sizes, loading and other structural requirements, etc. of a particular application. Also the provision of overlapping layers, areas of increased or decreased thickness for the first and second skins and the intermediate structure can chosen according to parameters such as weight requirements, sizes, loading and other structural requirements, etc. Similarly, the option to include holes or apertures in the various portions of the intermediate structure can be chosen according to parameters such as weight requirements, sizes, loading and other structural requirements, etc.

A winglet a shown in FIGS. 7A-8B can be manufactured as a component separate from the wings 215, and can then be attached to a wing 215, by means of fasteners (e.g., bolts, rivets, screws, etc.) and/or other fastening techniques.

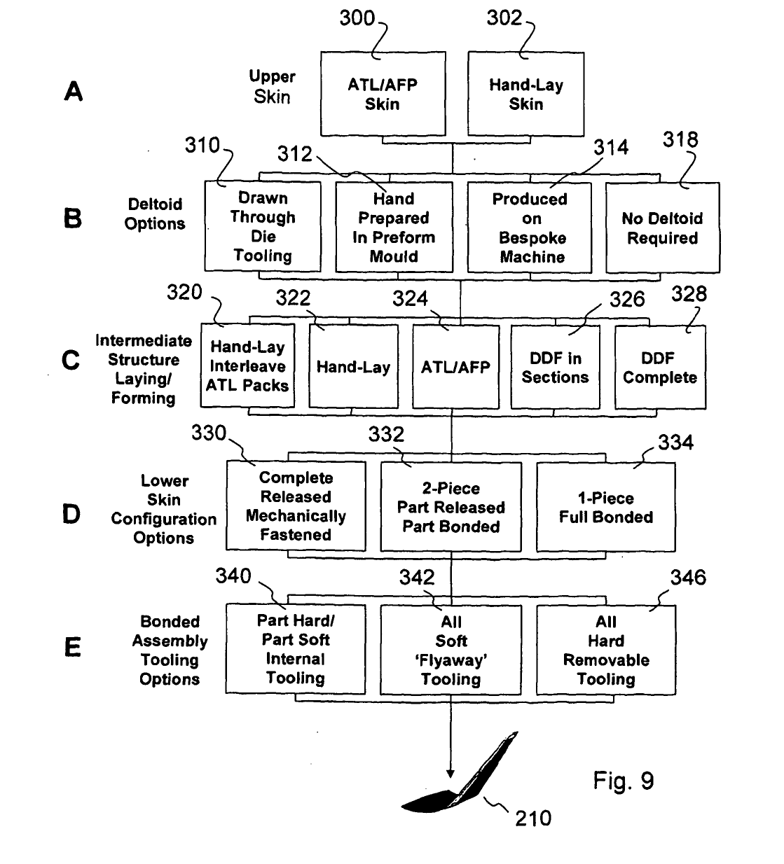

FIG. 9 illustrates options for various stages during the production of a winglet for particular applications. FIG. 9A illustrates that the skins can be laid using either an automated process 300 using an automatic tape layer and/or automatic fibre placement, or alternatively can be formed using a manual hand-lay system 302. Similarly, the formation of the deltoid fillers can be formed using a drawn through die tooling process 310, a hand prepared preformed mould process 312, a bespoke manufacture 314, or alternatively the deltoids could be omitted 316.

FIG. 9B illustrates that the intermediate structure 16 can be formed using a hand-laying process interleaving packs produced using an automated tape layer, 320, or using a hand-laying process 322, or using a fully automated automatic tape layer and/or automatic fibre placement process 324. The intermediate structure can be laid using a fully automated automatic tape layer and/or automatic fibre placement technology, or it can be constructed using double diaphragm forming in sections 326, or double diaphragm forming as a complete intermediate structure 328.

FIG. 9D illustrates various options for configuring the lower skin 214. This includes the lower skin being completely released and the mechanically fastened as illustrated, for example, in FIG. 3 or FIGS. 7A and 7B, or alternatively as a two piece part released and part bonded structure 332 as shown in FIG. 8B or as a one piece fully bonded structure 334. In the latter case, the mandrel structure needs to be configured such that it can be withdrawn through the curved shape of the winglet 210 using, for example, fully soft “flyaway” tooling which is retained within the winglet structure or a tooling structure which is dissolvable.

FIG. 9E illustrates an alternative bonding assembly tooling options. Thus, the tooling options can be part hard and part soft internal tooling 340 using an approach such as shown in FIG. 3 with hard mandrels and soft pressure tubes. Alternatively, as mentioned with regard to the lower skin configuration options, a soft flyaway tooling could be used using, for example, lightweight inflatable or foam-based structures. Optionally, techniques can be used for disintegrating and removing soft tooling structures. As a further alternative, the tooling can be formed of multiple hard removable tooling elements, such as mandrels for all of the cavity sections within the internal structure, as represented by option 346.

There has been described, a dual-skin structure that comprises a first skin, a second skin and an intermediate structure. The intermediate structure comprises a plurality of first contact portions connected to an interior surface of the first skin, a plurality of second contact portions connected to an interior surface of the second skin and a plurality of interconnecting web portions integral to the first and second contact portions and extending between ones of the first and second contact portions to form an internal supporting structure alternating between the interior surfaces of the first and second skins.

Although in the described examples, a single integral intermediate structure is described, in other examples, a plurality of separate intermediate structures could be provided.

An example embodiment is described in which the article is a winglet. The winglet includes an intermediate structure that defines channels, or waffles extending in a span-wise direction.

It should be noted that the intermediate structure could further define channels that extend instead, or in addition, in a chord-wise direction. It is to be noted that the invention is not limited to articles of manufacture in the form of winglets, but can be applied to other articles that comprise a dual-skin structure. Examples of such structures, by way of illustration only, could include, for example in the field of aeronautical or aerospace technologies, wings, tail planes, tail fins or other aerodynamic structures, or other structures such as, for example, the fuselage, engine mounts, engine housings, etc., of a manned or unmanned aircraft.

Although a variety of embodiments have been described herein, these are provided by way of example only, and many variations and modifications of such embodiments will be apparent to the skilled person and fall within the scope of the present invention, which is defined by the appended claims and their equivalents.

1-22. (canceled)

23. A method of forming an article that comprises a first skin, a second skin and an intermediate structure that comprises a plurality of first contact portions connected to an interior surface of the first skin, a plurality of second contact portions connected to an interior surface of the second skin and a plurality of interconnecting web portions integral to the first and second contact portions and extending between ones of the first and second contact portions to form an internal supporting structure alternating between the interior surfaces of the first and second skins, the method comprising:
separately forming the first skin, the second skin and the intermediate structure from composite materials; and
assembling the article using at least one method step of co-curing the first skin, the second skin and the intermediate structure.

24. The method of claim 23, wherein at least one of the first skin, the second skin and the intermediate structure comprises fibre-reinforced composite material.

25. The method of claim 24, wherein each of the first skin, the second skin and the intermediate structure comprises fibre-reinforced composite material.

26. The method of claim 24 or claim 25, wherein the fibre reinforcement is carbon fibre.

27. The method of claim 24, wherein the fibre reinforcement comprises laminated sheets of fibres.

28. The method of claim 23, wherein the article is elongate and tapers from a first end to second end so that a width and/or thickness of the article at the first end is greater than a width and/or thickness at the second end, and wherein respective channels formed between the intermediate structure and the first and second skins taper from the first end to the second end.

29. The method of claim 23, comprising forming the second skin by stacking sheets of pre-impregnated fibres on a first tool.

30. The method of claim 23, comprising forming the intermediate structure by stacking sheets of pre-impregnated fibres over mandrels and a second tool, the mandrels being releasably mounted on the second tool.

31. The method of claim 30, wherein the sheets of pre-impregnated fibres comprise petals of fibres interleaved such that the petals overlap at a first contact portion to provide the intermediate structure with a greater thickness at the first contact portion than at an intermediate portion.

32. The method of claim 31, wherein the first contact portion having a greater thickness is configured to receive a fastener for attaching the first skin

33. The method of claim 23, comprising forming a deltoid filler at the exterior of an angle formed between a contact portion and an intermediate portion of the intermediate structure.

34. The method of claim 33, wherein the deltoid filler comprises fibre-reinforced composite material.

35. The method of claim 23, wherein the intermediate structure is formed by stacking sheets of pre-impregnated fibres over mandrels and a second tool, the mandrels being releasably mounted on the second tool, the method further comprising:
forming the second skin and the intermediate structure;
forming a sub-assembly from the second skin and intermediate structure; and
releasing the second tool from the mandrels.

36. The method of claim 23, comprising forming the first skin by stacking sheets of pre-impregnated fibres on a third tool.

37. The method of claim 35, comprising forming at least a portion of the first skin by stacking sheets of pre-impregnated fibres on a third tool and adding a release film to the first skin.

38. The method of claim 35, comprising forming at least a portion of the first skin by stacking sheets of pre-impregnated fibres on a third tool without adding a release film to the first skin.

39. The method of claim 37, comprising:
placing the first skin or each portion of the first skin onto the intermediate structure of the sub-assembly;
introducing pressure bags into channels formed between the intermediate structure and the second skin;
co-curing the assembly formed from the first and second skins and the intermediate structure;
removing any portion of the first skin that had been provided with a release film;
removing the mandrels;
replacing any portion of the first skin that had been provided with a release film and securing any such portion of the first skin.

40. The method of claim 39, wherein replacing any portion of the first skin that had been provided with a release film comprises securing any such portion of the first skin using fasteners.

41. The method of claim 40, wherein the fasteners extend though the first skin into a contact portion of the intermediate structure at which petals of fibres overlap to provide the intermediate structure with a greater thickness at the contact portion than at an intermediate portion.

42. The method of claim 23 wherein the article comprises an aerofoil section wherein the first and second skins form first and second surfaces of the aerofoil section.

43. The method of claim 42, wherein the intermediate structure defines channels that extend in at least one of a span-wise or a chord-wise direction of the aerofoil section.

44. The method of claims 42, wherein the article is a winglet.

45. The method of claim 44, wherein the winglet is configured to extend upwards from the end of a wing.

46. A method of reinforcing an external angle formed between a first laminated composite member and a second laminated composite member, the second composite laminate member comprising a first portion adjacent the first composite laminate member and a second portion extended away from the first composite laminate member at an angle thereto, the method comprising forming an external deltoid filler formed of composite material in the external angle between the first laminated composite member and the second laminated composite member.

47. The method of claim 46, comprising forming the deltoid filler from pre-impregnated reinforcing fibres.

48. The method of claim 47, wherein the reinforcing fibres are carbon fibres.

49. The method of claim 46 wherein a form for the deltoid filler is at least partially formed from a part of a mandrel.

50. A method of forming an intermediate structure for an article that comprises a first skin, a second skin and the intermediate structure, the method comprising:
stacking sheets of pre-impregnated fibres over mandrels and a second tool, the mandrels being releasably mounted on the second tool, wherein the sheets of pre-impregnated fibres comprise petals of fibres interleaved such that the petals overlap at a first contact portion to provide the intermediate structure with a greater thickness at the first contact portion than at an intermediate portion.

51-53. (canceled)
